(19) United States
(12) Patent Application Publication
(10) Pub. No.: US 2026/0212591 A1
(43) Pub. Date: Jul. 23, 2026

(54) FAST LIGHT FIELD RENDERING FROM THREE-DIMENSIONAL (3D) REPRESENTATIONS

(71) Applicant: NVIDIA Corporation, Santa Clara, CA (US)

(72) Inventors: Jonghyun Kim, San Jose, CA (US); Cheng Sun, Taoyuan City (TW); Michael Stengel, San Jose, CA (US); Andrew Russell, Weston, FL (US); Jaehyun Jung, Winchester, MA (US); Shalini De Mello, San Francisco, CA (US); David Patrick Luebke, Charlottesville, VA (US)

(21) Appl. No.: 19/302,454

(22) Filed: Aug. 18, 2025

Related U.S. Application Data
(60) Provisional application No. 63/748,816, filed on Jan. 23, 2025.

(51) Int. Cl. G06T 15/50; G06T 15/06; G06T 15/20

(52) U.S. Cl. CPC G06T 15/50; G06T 15/06; G06T 15/20

(57) ABSTRACT

Systems and methods for fast light field rendering from a three-dimensional (3D) representation of a scene. In at least one embodiment, fast light field rendering exploits cached color values of a plurality of color planes corresponding to a reference view and cached transmittance values of a plurality of transmittance planes corresponding to the reference view to composite a light field quilt via a single sweep through a plurality of sampling planes/volume chunks, thereby enhancing computational efficiency during rendering.

### CROSS-REFERENCE TO RELATED APPLICATIONS

This application claims the benefit of U.S. Provisional Application No. 63/748,816, filed Jan. 23, 2025, which is hereby incorporated by reference in its entirety.

### FIELD

Rendering techniques for three-dimensional displays, and more particularly, systems and methods for rendering a light field from a variety of different types of three-dimensional (3D) representations.

### BACKGROUND

Recent advancements in radiance fields have significantly improved both the quantity and quality of 3D content. Radiance fields represent 3D scenes by encoding density and color values across spatial coordinates, enabling detailed and realistic reconstructions of complex scenes. Neural Radiance Fields (NeRFs) have lowered the barriers for non-experts to create 3D content by enabling continuous view synthesis from sparse input images, allowing complex 3D scenes to be reconstructed with high precision. However, the long training and rendering times associates with NeRFs have led to the exploration of alternative representations, such as a 3D Gaussian Splatting (3DGS) representation or a Sparse Voxels Grid (SVG), to improve rendering efficiency and better suit real-time applications. Additionally, radiance fields have become a core component in modern 3D generative models, enabling high-fidelity 3D outputs and ensuring spatial consistency across various applications.

Like other 3D content, radiance fields are most effectively visualized using 3D displays. The ability of radiance fields to represent complex 3D structures aligns naturally with the capabilities of light field displays, which physically replicate the light rays of 3D scenes. Recent commercially available light field displays offer high spatial and angular resolutions, enabling precise and immersive 3D visualization. These displays provide binocular disparity and motion parallax, leveraging human depth perception to allow users to intuitively grasp 3D structures.

Light field displays fundamentally face substantial computational overhead in rendering due to their unique optical design. Unlike conventional two-dimensional (2D) displays, light field displays require the generation of multiple perspective views to reconstruct a full light field, necessitating a dense array of rays projected at precise angles. This significantly increases the computational burden compared to single-view displays. Furthermore, precise optical alignment between the display panel and the lens array is critical; even minor angular or spatial misalignment during manufacturing can lead to incorrect ray mappings that degrade visual quality. These misalignments demand a per-device calibration process to ensure accurate ray alignment, further complicating the rendering pipeline.

To address these challenges, many light field displays adopt view interpolation techniques that calculate subpixel colors based on nearby sampling rays. While this approach reduces the need for generating every view explicitly, it still relies on rendering many high-resolution perspective images to maximize the visual experience that the display hardware can provide. As a result, the rendering process remains computationally intensive, particularly for dynamic or real-time applications. These fundamental inefficiencies limit the scalability and real-time performance of light field displays, especially when used in conjunction with radiance fields.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A provides a block diagram of an example system for rendering a light field quilt, in accordance with an embodiment;

FIG. 1B illustrates a workflow provided by system for rendering a light field quilt, in accordance with an embodiment;

FIG. 2A is a flow diagram of a method for rendering a light field quilt, in accordance with an embodiment;

FIG. 2B is a flow diagram of a method for rendering a light field quilt, in accordance with an embodiment;

FIG. 2C illustrates an operation performed by a method for rendering a light field quilt, in accordance with an embodiment;

FIG. 2D illustrates spatial positions of a collection of perspective cameras corresponding to a 3D display, a reference camera, and a series of forward sweeping planes, in accordance with an embodiment;

FIG. 3A provides an algorithm, in accordance with an embodiment, for rendering a light field quilt from a 3DGS representation or from an SVG, in accordance with an embodiment;

FIG. 3B illustrates a process for rendering a light field quilt from a 3DGS representation, in accordance with an embodiment;

FIG. 3C illustrates a process for rendering a light field quilt from an SVG, in accordance with an embodiment;

FIG. 4 illustrates an example parallel processing unit suitable for use in implementing one or more embodiments;

FIG. 5A is a conceptual diagram of a processing system, implemented using the PPU of FIG. 4, suitable for use in implementing one or more embodiments;

FIG. 5B illustrates an exemplary system in which the various architecture and/or functionality of the various previous embodiments may be implemented;

FIG. 5C illustrates components of an exemplary system that can be used to train and utilize machine learning, suitable for use in implementing one or more embodiments; and

FIG. 6 illustrates an exemplary streaming system suitable for use in implementing one or more embodiments.

### DETAILED DESCRIPTION

Systems and methods provide fast light field rendering from a variety of different three-dimensional (3D) representations (e.g., radiance field representations of scenes or objects), including, e.g., neural radiance fields (NeRFs), 3D Gaussian splatting (3DGS) representations, and sparse voxel grid (SVG) representations. In at least one embodiment, a system or a method determines a plurality of volume chunks within the 3D representation and, for sampling points in each volume chunk, computes and caches transmittance and color values corresponding to a reference viewpoint. In at least one embodiment, the system or the method performs a single-pass plane sweep operation to generate the light field quilt. The single-pass plane sweep operation uses the cached transmittance and color values to approximate transmittance and color values corresponding to multiple quilt viewpoints, enabling simultaneous generation of multiple perspective view images, each corresponding to a unique viewpoint. This approach significantly reduces computational overhead compared to rendering each view independently, allowing for real-time or near-real-time rendering of complex 3D scenes on, e.g., light field displays, multi-view displays, or holographic displays.

According to one or more embodiments, a method is provided for rendering multiple view images from a three-dimensional (3D) representation of a scene. The method includes obtaining the 3D representation, determining a plurality of volume chunks, and computing, for respective sampling points in each of the plurality of volume chunks, transmittance and color values corresponding to rays extending from the respective sampling points to a reference view, thereby providing a plurality of color planes comprising computed color values and a plurality of transmittance planes comprising computed transmittance values. The method additionally includes caching the computed color values and the computed transmittance values and performing a plane sweep operation to generate the light field quilt.

In at least one embodiment of the method, the light field quilt comprises a plurality of view images corresponding to a plurality of views, and the plane sweep operation approximates color and transmittance values corresponding to pixels of the plurality of view images using the cached color values and the cached transmittance values.

In at least one embodiment of the method, the 3D representation is a neural radiance field (NeRF), and determining the plurality of volume chunks includes generating, by using the NeRF to compute density values for different points in the scene, a depth map of the scene, and partitioning the scene into the plurality of volume chunks based on the depth map.

In at least one embodiment of the method, the 3D representation is a 3D Gaussian splatting (3DGS) representation or a sparse voxel grid (SVG) representation, and determining the plurality of volume chunks includes culling primitives based on the reference view, sorting remaining primitives based on their distance to the reference view, and partitioning the scene into the plurality of volume chunks such that each volume chunk contains a number of primitives that falls within a threshold range of a mean number of primitives or a median number of primitives.

In at least one embodiment of the method, each volume chunk of the plurality of volume chunks comprises a uniform number of sampling points.

In at least one embodiment of the method, a number of sampling points in a respective volume chunk of the plurality of volume chunks is determined from a distance of the respective volume chunk from a focal depth of the reference view.

In at least one embodiment of the method, computing the transmittance values and the color values comprises rasterizing primitives assigned to each respective volume chunk of the plurality of volume chunks onto a 2D grid located at a midplane of the respective volume chunk.

In at least one embodiment of the method, performing the plane sweep operation comprises, for one or more respective volume chunks of the plurality of volume chunks, computing a color contribution and a transmittance contribution of the respective volume chunk for one or more respective pixels in the light field quilt by, for each respective pixel of the one or more respective pixels: determining a point of intersection of a ray corresponding to the respective pixel and a sampling plane corresponding to the volume chunk, and approximating, based on the determined point of intersection and one or more cached transmittance values and one or more cached color values, a respective transmittance contribution and a respective color contribution corresponding to the respective pixel. In at least one embodiment, performing the plane sweep operation further includes compositing the respective transmittance contributions with corresponding previously computed transmittance values and compositing the respective color contributions with corresponding previously computed color values.

In at least one embodiment, the method further includes specifying parameters of the light field quilt, wherein the parameters of the light field quilt comprise: a number of views in an x-direction, a number of views in a y-direction, an angular spread of views in the x-direction, an angular spread of views in the y-direction, and a resolution of each view.

In at least one embodiment of the method, the light field quilt comprises a plurality of perspective view images, each perspective view image corresponding to a unique view.

In at least one embodiment, the method further includes providing the light field quilt to a 3D display device for visualization, wherein the 3D display device is one of a light field display, a multi-view display, or a holographic display.

According to one or more embodiments, a non-transitory computer readable medium is provided having stored thereon processor-executable instructions that, when executed by one or more processors, cause the one or more processors to perform the method and/or any embodiment thereof.

According to one or more embodiments, a system for rendering multiple view images from a three-dimensional (3D) representation of a scene is provided. The system includes one or more processors configured to obtain the 3D representation, determine a plurality of volume chunks, and compute, for respective sampling points in each of the plurality of volume chunks, transmittance and color values corresponding to rays extending from the respective sampling points to a reference view, thereby providing a plurality of color planes comprising computed color values and a plurality of transmittance planes comprising computed transmittance values. The one or more processors are further configured to cache the computed color values and the computed transmittance values and perform a plane sweep operation to generate the light field quilt. The system further includes one or more memories configured to store computed color values and the computed transmittance values.

In at least one embodiment of the system, the light field quilt includes a plurality of view images corresponding to a plurality of views, and wherein the plane sweep operation approximates color and transmittance values corresponding to pixels of the plurality of view images using the cached color values and the cached transmittance values.

In at least one embodiment of the system, the 3D representation is a neural radiance field (NeRF), and wherein determining the plurality of volume chunks includes generating, by using the NeRF to compute density values for different points in the scene, a depth map of the scene, and partitioning the scene into the plurality of volume chunks based on the depth map.

In at least one embodiment of the system, the 3D representation is a 3D Gaussian splatting (3DGS) representation or a sparse voxel grid (SVG) representation, and determining the plurality of volume chunks includes culling primitives based on the reference view, sorting remaining primitives based on their distance to the reference view, and partitioning the scene into the plurality of volume chunks such that each volume chunk contains a number of primitives that falls within a threshold range of a mean number of primitives or a median number of primitives.

In at least one embodiment of the system, each volume chunk of the plurality of volume chunks includes a uniform number of sampling points.

In at least one embodiment of the system, a number of sampling points in a respective volume chunk of the plurality of volume chunks is determined from a distance of the respective volume chunk from a focal depth of the reference view.

In at least one embodiment of the system, performing the plane sweep operation includes, for one or more respective volume chunks of the plurality of volume chunks computing a color contribution and a transmittance contribution of the respective volume chunk for one or more respective pixels in the light field quilt by, for each respective pixel of the one or more respective pixels: determining a point of intersection of a ray corresponding to the respective pixel and a sampling plane corresponding to the volume chunk, and approximating, based on the determined point of intersection and one or more cached transmittance values and one or more cached color values, a respective transmittance contribution and a respective color contribution corresponding to the respective pixel. In at least one embodiment, performing the plane sweep operation further includes compositing the respective transmittance contributions with corresponding previously computed transmittance values and compositing the respective color contributions with corresponding previously computed color values.

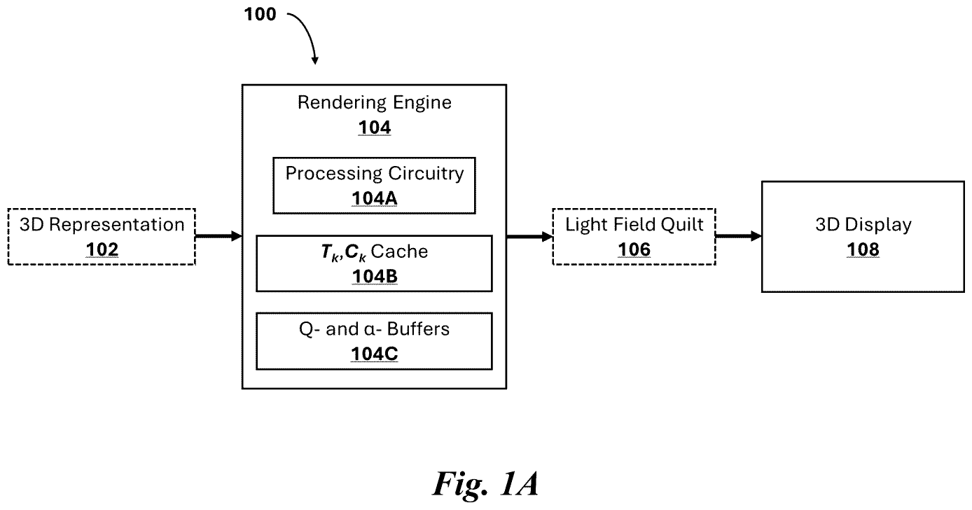

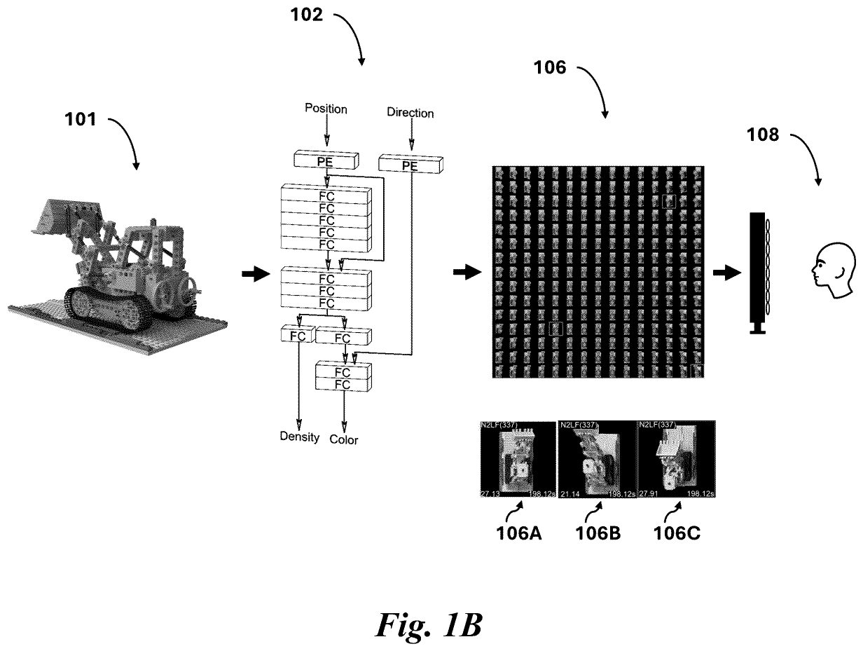

FIG. 1A illustrates a block diagram of an example system 100, in accordance with an embodiment, for rendering a light field quilt from a 3D representation. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 100 is within the scope and spirit of embodiments of the present disclosure.

System 100 includes a rendering engine 104 that receives a 3D Representation 102 (e.g., NeRF, 3DGS representation, or SVG) as input and generates the light field quilt 106 as output. The light field quilt 106 includes a plurality of view images captured from a plurality of slightly shifted views. The light field quilt 106 is provided as input to 3D display 108, which can be, e.g., a light field display, a multi-view display, or a holographic display.

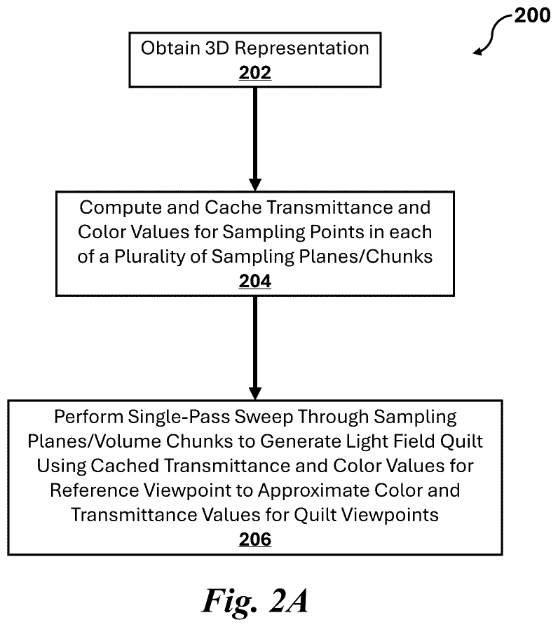

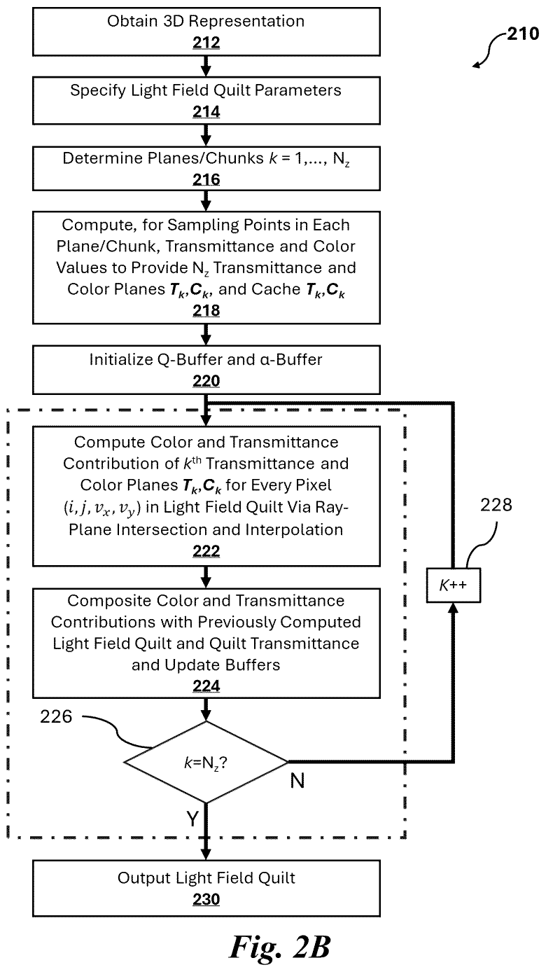

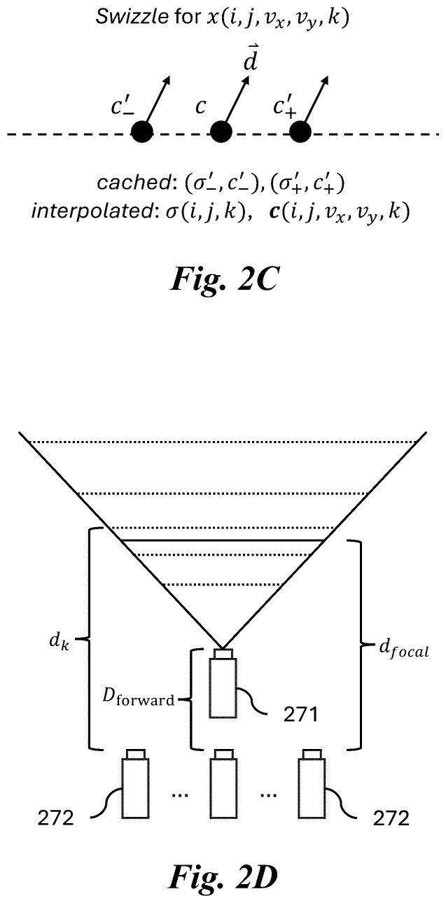

The rendering engine 104 includes processing circuitry 104A, transmittance plane/color plane cache 104B, and light field quilt (Q) and alpha (α) buffers 104C. The processing circuitry 104A is configured to carry out a process (e.g., the method 200 illustrated by the flow diagram of FIG. 2A of the method 210 illustrated by the flow diagram of FIG. 2B) for generating the light field quilt 106 from the 3D Representation 102.

In at least one embodiment, the processing circuitry 104A writes to transmittance plane/color plane cache 104B, during generation of the light field quilt 106, transmittance planes Tₖ and color planes Cₖ (for k=1, 2, . . . , N_{z}) computed for a reference view (e.g., a central view of light field quilt 106). Each of the transmittance planes Tₖ and color planes Cₖ is computed based on the 3D representation 102. In at least one embodiment, the processing circuitry 104A also writes and iteratively updates, during generation of the light field quilt 106, a cumulative light field quilt (Q) and a cumulative quilt transmittance (T) in Q- and α-buffers 104C.

FIG. 1B illustrates a workflow provided by system 100, in accordance with an embodiment. The workflow begins with a 3D scene 101. The 3D scene is sparsely sampled from a plurality of viewpoints to produce a plurality of 2D images, and a 3D representation 102 (depicted as a NeRF in FIG. 1B) is constructed from the plurality of sparsely sampled 2D images. The 3D representation 102 is provided as input to a system (e.g., system 100 of FIG. 1A) or a method (e.g., method 200 of FIG. 2A) for rendering a light field quilt, and light field quilt 106 is produced as output. As depicted in FIG. 1B, light field quilt 106 is a 15×15 light field quilt that includes 225 unique, 512×512 pixel, 2D images (including 2D perspective view images 106A, 106B, and 106C), each corresponding to a unique viewpoint. The light field quilt 106 serves as a base input image for 3D display 108, which can be any of a multi-view display, an integral imaging display, a computational light field display, or a holographic display.

FIG. 2A illustrates a flowchart of a method 200 for rendering a light field quilt from a 3D representation, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

At 202, method 200 obtains a 3D representation. In various embodiments, the 3D representation may be in various forms, e.g., a neural radiance field (NeRF), a 3D Gaussian splatting (3DGS) representation, or a sparse voxel grid (SVG). The 3D representation can encode, e.g., the geometry, color, and other attributes of a 3D scene or object.

At 204, transmittance and color values are computed (e.g., for a reference view) and cached for sampling points in each of a plurality of sampling planes/volume chunks. In one or more embodiments, a set of sampling planes/volume chunks that span a 3D space represented by the 3D representation are determined and, for each sampling point within these planes/chunks, transmittance and color values are computed based on the 3D representation. These computed values are then cached for access during subsequent steps.

At 206, method 200 performs a single-pass sweep through the sampling planes/volume chunks to generate a light field quilt. The single-pass sweep utilizes the cached transmittance and color values computed at 204 to approximate (e.g., interpolate) color and transmittance values for multiple quilt views. The single-pass sweep facilitates efficient generation of the light field quilt, as it can be parallelized and avoids the need to recompute values for each individual view in the quilt.

In one or more embodiments, during the single-pass sweep, method 200 interpolates between cached values (which are, e.g., determined from the location of ray-plane intersection points of rays corresponding to individual pixels in the light field quilt) to approximate the appropriate color and transmittance values for each pixel in the light field quilt. The single-pass sweep enables method 200 to generate multiple view images corresponding to different perspective views of the light field quilt in parallel, significantly reducing the computational overhead (as compared to rendering each view image independently). The efficiency realized through the single-pass sweep facilitates real-time or near-real-time rendering of light field quilts from any 3D representation. According to one embodiment, method 200 provides 200+ FPS at 512p across 45 views, enabling seamless, immersive 3D interaction and representing a 22×speedup (as compared to conventional techniques that render each view independently) while preserving image quality.

FIG. 2B illustrates a flowchart of a method 210 for rendering a light field quilt from a 3D representation, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 210 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 210 is within the scope and spirit of embodiments of the present disclosure.

Method 210 obtains, at 212, a 3D neural representation as input and generates, at 230, a light field quilt as output. The light field quilt to be generated (and output at 230) can be expressed as:

$$Q = C o n c a {t}_{∀ {v}_{x} , {v}_{y}} \{ {I}_{Q} ( {v}_{x} , {v}_{y} ) \} = C o n c a {t}_{∀ i , j , {v}_{x} , {v}_{y}} \{ c ( i , j , {v}_{x} , {v}_{y} ) \} ,$$

where indices vₓ=1, 2, . . . , Vₓ and v_{y}=1, 2, . . . , V_{y} designate perspective view images within the light field quilt, I_{Q}(Vₓ, V_{y}) denotes the rendered perspective view image from the direction specified by [vₓ, V_{y}], indices i=1, 2, . . . , Nₓ and j=1, 2, . . . , N_{y} designate pixels within a rendered perspective view image, and C(i, j, vₓ, v_{y}) denotes the color value for the pixel specified by [i, j] in the perspective view image specified by [vₓ, v_{y}].

At 214, method 210 specifies parameters of the light field quilt to be generated. The parameters include a number of views in an x-direction (Vₓ), a number of views in a y-direction (V_{y}), an angular spread of the views in the x-direction (θₓ), an angular spread of the views in the y-direction (θ_{y}), and the resolution of each view (Nₓ×N_{y}).

At 216, method 210 determines a plurality of sampling planes/volume chunks, each of which is located at a different distance from a reference view (e.g., a view corresponding to a central view [vₓ_{_{c}}, v_{y}_{_{c}}] of the light field quilt Q). In various embodiments, different techniques are employed for determining the sampling planes at 216.

At 218, method 210 computes, for respective sampling points in each of the plurality of sampling planes/volume chunks determined at 216, transmittance and color values corresponding to rays extending from the respective sampling points to the reference viewpoint, thereby providing a plurality of transmittance planes Tₖ and a plurality of color planes Cₖ (for k=1, 2, . . . , N_{z}). At 218, method 210 also writes the plurality of transmittance planes Tₖ and the plurality of color planes Cₖ to cache. In at least one embodiment, each transmittance plane Tₖ includes a transmittance value for each of PₛNₓ×PₛN_{y} sampling points (where Pₛ is a resolution scaling hyperparameter), and each color planes Cₖ includes a color value for each of the PₛNₓ×PₛN_{y} sampling points. In at least one embodiment, Pₛ≥1 to provide a plane super-sampling scale. In at least one embodiment, Pₛ=f(δ) is a function of a distance δ of the k^{th} sampling plane from a focal depth of a camera corresponding to the reference viewpoint.

At 220, method 210 initializes a light field quilt buffer (Q) and a transmittance buffer (T) and sets k=1. At 222 through 224, method 210 computes a light field corresponding to a single sampling plane k. Method 210 repeats 222 and 224 for each sampling plane k=1, 2, . . . , N_{z} determined at 216. At 222, method 210 computes a color contribution of the k^{th} color plane Cₖ and a transmittance contribution of the k^{th} transmittance plane Tₖ for every pixel (i, j, vₓ, v_{y}) in the light field quilt Q via ray-plane intersection and interpolation. Specifically, at 222, the process determines, for every ray corresponding to a respective pixel (i, j, vₓ, v_{y}) in the light field quilt Q, a respective point of intersection with the k^{th} sampling plane/volume chunk, and further determines, based on the respective point of intersection and via interpolation (i.e., using values from the cached transmittance planes Tₖ and color planes Cₖ), a color and a transmittance value. In various embodiments, different types of interpolation, e.g., nearest-neighbor interpolation, bilinear interpolation, or bicubic interpolation, are used to determine the color and transmittance values at 222. As a result of step 222, a light field slice corresponding to the k^{th} sampling plane/volume chunk is produced.

At 224, method 210 composites the light field slice computed at 222 with an intermediate light field quilt (formed by compositing light field slices computed in prior iterations) stored in a light field quilt buffer (i.e. the Q-buffer) and updates the light field quilt buffer and the accumulated transmittance buffer. Specifically, at 224, method 210 computes, for every ray corresponding to a respective pixel (i, j, vₓ, V_{y}) in the light field quilt Q, (i) an updated color value by adding (a) a stored color value from the Q-buffer with (b) the product of the color value computed at 212, a stored accumulated transmittance value from the α-buffer, and an opacity derived from the transmittance computed at 222. Also at 224, the updated color value for every ray corresponding to a respective pixel (i, j, vₓ, V_{y}) in the light field quilt Q is stored in the Q-buffer, and the updated accumulated transmittance value for every ray corresponding to a respective pixel (i, j, vₓ, V_{y}) in the light field quilt Q is stored in the α-buffer.

Both (i) computation of the color values at 222 and (ii) computation of updated color values and updated accumulated transmittance values at 224 are fully-parallelizable. The computations performed at 222 and 224 can be expressed as:

$$Q = {\sum }_{k = I}^{{N}_{Z}} {Swizzle}_{∀ i , j , {v}_{x} , {v}_{y}} ( {T}_{i , j , {v}_{x} , {v}_{y} {v}_{y}} , {T}_{k} , {C}_{k} ) ,$$

where the Swizzle function samples transmittance and color values from Tₖ, Cₖ via ray-plane intersection and interpolation and outputs the light field for the k^{th} sampling plane and where T_{i,j,v}_{ₓ}_{,v}_{_{y}} is the accumulated transmittance (for sampling planes m=1, 2, . . . , k−1). Each possible ray impacts a single pixel in the Q-buffer and the α-buffer, and therefore the computations at 222 and 224 can be carried out in parallel using the cached k^{th} color plane Cₖ and k^{th} transmittance plane Tₖ. In at least one embodiment, NVIDIA's Compute Unified Device Architecture (CUDA) platform is harnessed to enable multiple GPU cores to simultaneously perform the computations at 222 and 224, enabling significant acceleration.

FIG. 2C illustrates the Swizzle operation for a point x(i, j, vₓ, v_{y}, k) on the current plane k that corresponds to pixel (i, j) and camera (vₓ, v_{y}) with precomputed ray direction d(i, j, vₓ, v_{y}). As illustrated in FIG. 2C, the Swizzle operation uses ray-plane intersection and cached density and color values for neighboring points, i.e., (σ′_,c′_) and (σ′₊,c′₊), to interpolate a density value σ(i, j, k) and a color value c(i, j, vₓ, v_{y}, k) for rendering the light field quilt. The Swizzle operation can be performed in parallel for every pixel-camera combination (i.e., for every value of (i, j, vₓ, v_{y}) in the light field quilt). In at least one embodiment, NVIDIA's Compute Unified Device Architecture (CUDA) platform is harnessed to enable multiple GPU cores to simultaneously perform the Swizzle operation for every pixel-camera combination, enabling significant acceleration.

At 226, method 210 determines whether the light field slice that has just been computed is the final light field slice (i.e. k=N_{z}). If not, the process proceeds to 228, increments k, and then returns to 222 to compute the next light field slice. Alternatively, if the final light field slice k=N_{z} has been computed, method 210 proceeds to 230 and outputs the light field quilt (i.e. the values stored in the Q-buffer after N_{z} iterations).

In one or more embodiments, the 3D representation obtained at 212 is an implicit 3D neural representation (e.g., a NeRF), and the sampling planes/volume chunks are determined at 216 by first predicting a depth map to identify locations of physical objects in the volume represented by the NeRF and subsequently dividing the volume represented by the NeRF into a plurality of volume chunks (i.e., that correspond to the sampling planes/volume chunks k=1, 2, . . . , N_{z}) that each contain a similar number of points that correspond to physical objects. In at least one embodiment, the sampling planes/volume chunks are determined at 216 by (i) performing coarse sampling of the volume represented by the NeRF by determining, for every ray corresponding to an image of resolution PₛNₓ×PₛN_{y} pixels [i, j] captured from a reference viewpoint (e.g., a viewpoint corresponding to a central view [vₓ_{_{c}}, v_{y}_{_{c}}] of the light field quilt Q), a respective point of intersection with a coarse sampling plane, (ii) determining density variations between consecutive coarse sampling planes along each ray, and (iii) partitioning, based on the determined density variations, the volume represented by the NeRF into the plurality of fine sampling planes (or “volume chunks”), e.g., by slicing parallel to the xy-plane. In at least one such embodiment, the computation of transmittance and color values at 218 is skipped for sampling points in sampling planes/volume chunks k=1, 2, . . . , N_{z} that correspond to coarse sampling points computed during the determination of sampling planes/volume chunks at 216. In at least one such embodiment, during subsequent steps 222 and 224, ray intersection points that are interpolated with sampling points revealed to be empty space (e.g., each of the PₛNₓ×PₛN_{y} sampling points in each of the N_{z} sampling planes/volume chunks having an α-value of 0) are skipped.

In one or more embodiments, the 3D representation obtained at 212 is an explicit 3D neural representation (e.g., a 3DGS representation or an SVG), and the sampling planes are determined at 216 by (i) culling primitives (e.g., 3D Gaussians) by the given reference camera and sorting the remaining primitives based on their z-distance to the reference camera, (ii) partitioning the volume represented by the explicit 3D neural representation into a plurality of volumes (i.e., “volume chunks”) by slicing parallel to the xy-plane such that each resulting volume has a similar number of 3D Gaussian primitives—thus forming volume chunks k=1,2, . . . , N_{z}. In at least one such embodiment, the plurality of transmittance planes Tₖ and the plurality of color planes Cₖ (for k=1, 2, . . . , N_{z}) are computed at by (iii) rasterizing each 3D Gaussian primitive assigned to the k^{th} volume chunk onto a 2D grid at a midplane of the k^{th} volume chunk.

In one or more embodiments, the sampling planes determined at 216 each include a uniform number of sampling points PₛNₓ×PₛN_{y} (i.e., Pₛ is a constant). In one or more embodiments, the sampling planes determined at 216 include a number of sampling points P_{N}_{_{z}}Nₓ×P_{N}_{_{z}}N_{y} where P_{N}_{_{z}}=f(δ) (where δ is a distance of the N_{z}^{th} sampling plane from a focal depth of the reference camera). In at least one such embodiment, f(δ) is a decreasing function such that the number of sampling points per sampling plane decreases as the distance of the sampling plane from the focal depth of the reference camera increases. As a result, fewer computations (as compared to the case where Pₛ is a constant) are required to determine the transmittance planes Tₖ and the color planes Cₖ located far from the focal depth of the reference camera, thereby increasing the speed at which the light field quilt is rendered.

In one or more embodiments, the plurality of transmittance planes Tₖ and the plurality of color planes Cₖ (for k=1, 2, . . . , N_{z}) are computed at 218 by (i) determining a plurality of uniformly spaced sampling planes and including a uniform number of sampling points PₛNₓ×PₛN_{y}, (ii) blurring and downsampling sampling planes distal from the focal depth of the reference camera (e.g., by combining sampling points—effectively decreasing the value of Pₛ), and (iii) combining multiple sampling planes distal from the focal depth of the reference camera together (effectively decreasing N_{z} and thereby reducing the computational workload of steps 222 and 224 and increasing the speed at which the light field quilt is rendered).

FIG. 2D illustrates spatial positions of a collection of perspective cameras corresponding to a 3D display, a reference camera, and a series of forward sweeping planes, in accordance with one or more embodiments. A light field quilt (e.g., generated as output at 230 by method 210) corresponds to a 3D display (e.g., 3D display 108 of system 100) “window” (or focal plane) for a viewer to observe the virtual world. The center location of the focal plane can be defined by the reference camera (e.g., reference camera 271) and a camera-to-plane distance D_{focal}. The size of the focal plane is derived from the field of view θₓ, θ_{y} of reference camera 271. The viewing angles of the 3D display are defined by φₓ, φ_{y}. The visible volume to the 3D display is determined by maximum viewing angles.

In one or more embodiments, the reference camera 271 is used to create a series of forward-sweeping planes and adjusted to cover the maximum viewing angle. In one or more embodiments, a distance D_{forward} from the reference camera 271 is specified as:

$${D}_{forward} = {max}_{k ∈ \{ x , y \}} {D}_{focal} \cdot \frac{tan ( 0.5 {ϕ}_{k} )}{tan ( 0.5 {ϕ}_{k} ) + tan ( 0.5 {θ}_{k} )} ,$$

and the field of view of the reference camera 271 is specified as:

$${θ}_{k ∈ \{ x , y \}}^{′} = 2 \cdot arctan ( \frac{{D}_{focal} \cdot tan ( 0.5 {θ}_{k} )}{{D}_{focal} - {D}_{forward}} ) .$$

As a result, the volume to display behind the focal plane is entirely visible by the reference camera 271. However, some area between the perspective cameras 272 and the focal plane is lost. In one or more embodiments, a hyperparameter D_{shift} can be introduced to account for the lost area between the perspective cameras 272 and the focal plane by moving the reference camera 271 backward: D_{forward}←D_{forward}−D_{shift}.

In one or more embodiments, sweeping planes are generated (e.g., at 218 of method 200) by rendering the scene's primitive chunks or volume chunks for the reference camera 271. Each forward-sweeping plane is denoted as T∈ [symbol] ^{N}^{_{chunk}}^{×(P}^{ₛ}^{·N}^{_{y}}^{)×(P}^{ₛ}^{·N}^{ₓ}⁾ for transmittances and C∈ [symbol] ^{N}^{_{chunk}}^{×(P}^{ₛ}^{·N}^{_{y}}^{)×(P}^{ₛ}^{·N}^{ₓ}^{)×3} for RGB colors, where N_{chunk} is the total number of chunks. The light field quilt is rendered by alpha composition (e.g., at 222 through 228), efficiently using the forward-sweeping planes. The quilt Q∈ [symbol] ^{V}^{_{y}}^{×V}^{ₓ}^{×N}^{_{y}}^{×N}^{ₓ}^{×3} is a 2D array of perspective views formed by moving the reference camera 271 along its horizontal and vertical directions (corresponding to the positions of perspective cameras 272). In at least one embodiment, camera offsets (Δₓ, Δ_{y}) are linearly interpolated in the angular domain of viewing angles, and their principal points (cₓ, c_{y}) aim toward the focal plane's center such that the N_{y}×Nₓ rays from all quilt views converge at the focal plane. The x components are provided by:

$${ρ}_{j} = {ϕ}_{x} \cdot ( \frac{j - 1}{{V}_{x} - 1} - \frac{1}{2} ) , {Δ}_{x} = {D}_{focal} \cdot tan ( {ρ}_{j} ) , {c}_{x} = \frac{tan ( {ρ}_{j} )}{tan ( 0.5 {θ}_{x} )}$$

where j∈[1, Vₓ] is the column index to the quilt views, and cₓ is in a normalized image domain (i.e., image border at ±1). For normalized pixel x-coordinates u∈[0,1] on the j-th column of quilts, their projected coordinate to the k-th forward-sweeping planes at distance dₖ is:

$${u}^{′} = \frac{{( {D}_{focal} - {d}_{k} ) \cdot tan ( {ρ}_{J} )}^{\overbrace{Coordinate of the principal point .}} + {{d}_{k} \cdot tan ( 0.5 {θ}_{x} ) \cdot u}^{\overbrace{Offset from the p rincipal point .}}}{( {d}_{k} - {D}_{forward} ) \cdot tan ( 0.5 {θ}_{x}^{′} )} .$$

The above equations are extended in an appropriate fashion for the y components. Quilt pixels are projected onto the sweeping planes and C and T are sampled, e.g., via bilinear or nearest-neighbor interpolation. The sampled series of colors cₖ and transmittance values Tₖ are blended into a final pixel color where:

$$C = {\sum }_{k = 1}^{{N}_{chunk}} ( {\prod }_{j = 1}^{j < k} {T}_{j} ) \cdot {C}_{k} ,$$

where the color cₖ is already weighted by alpha opacity. In at least one embodiment, an 8 bits unsigned integer is used to store C and T leading to similar blending quality comparing to using 32 bits float (while providing significantly less memory usage and faster rendering).

Embodiments provide multiple algorithms, e.g., 3DGS-to-Light-Field (G2LF), Sparse-Voxels-to-Light-Field (V2LF), and NeRF-to-Light-Field (N2LF), for fast rendering (e.g., in real time) of a 3D representation for a light field display. The algorithms efficiently generate high-resolution light field quilts by significantly reducing computational overhead while maintaining high rendering accuracy. The high-resolution light field quilts include multiple view images, and in one or more embodiments, each view of the multiple view images is rendered as a perspective view captured by a perspective camera.

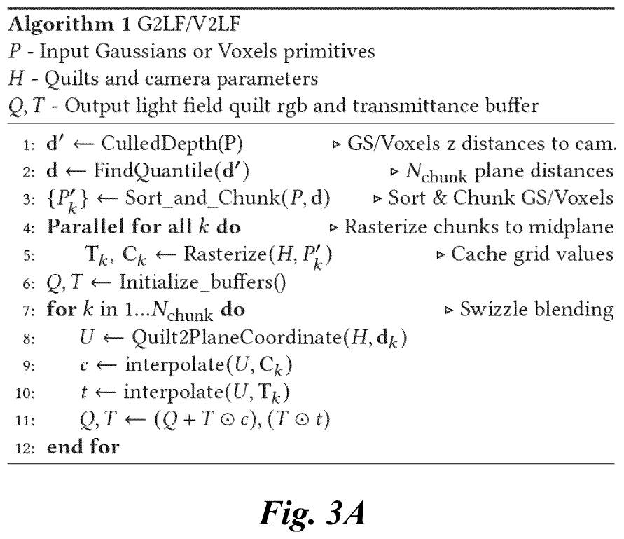

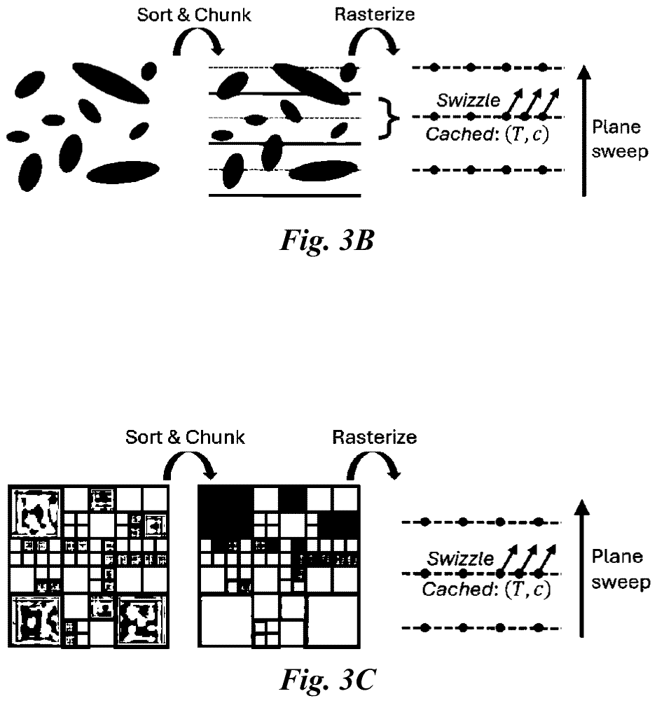

FIG. 3A provides an algorithm, referred to as 3D-Gaussians-to-Light-Field (G2LF) when input is provided in the form of 3D Gaussian Splatting (3DGS) representation or as Sparse-Voxels-to-Light-Field (V2LF) when input is provided in the form of a Sparse Voxel Grid (SVG) representation, for rendering a light field quilt. G2LF/V2LF includes a series of steps that efficiently process and transform the 3DGS or SVG representation into a format suitable for display on a light field display. G2LF/V2LF receives input in the form of a collection of primitives P (i.e., Gaussians or voxels) and view parameters H (i.e., light field quilt and camera parameters, e.g., a number of views in an x-direction (Vₓ), a number of views in a y-direction (V_{y}), a resolution of each view (Nₓ×N_{y}), etc.). G2LF/V2LF renders a set of V=(Vₓ×V_{y}) perspective viewpoints that collectively form a light field quilt accumulated in a light field quilt RGB buffer Q and a transmittance buffer T.

At step 1, G2LF/V2LF culls the 3D primitives (Gaussians or voxels) based on a view frustum corresponding to a reference viewpoint (thereby reducing computational load by eliminating primitives not visible from the reference viewpoint) and computes z-distances (d′) of the remaining primitives to the reference camera using a CulledDepth function. At step 2, G2LF/V2LF determines midplane distances (d) along the z-axis for the N_{chunk} primitive chunks using the FindQuantile function, which analyzes the distribution of z-distances (d′) to ensure each chunk contains a similar number of primitives (thereby maintaining consistent computational complexity across chunks). At step 3, G2LF/V2LF sorts the primitives based on their z-distances and assigns each primitive to one of the N_{chunk} volume chunks using the Sort_and_Chunk function.

At steps 4 and 5, the N_{chunk} chunks are independently rasterized in parallel using a Rasterize function, which projects the 3D primitives within each respective chunk onto a grid located at the midplane of the respective chunk, thereby generating transmittance and color values of transmittance planes Tₖ and color planes Cₖ (for k=1, 2, . . . , N_{chunk}). G2LF/V2LF also caches the grid values (i.e., the transmittance and color values output by the Rasterize function).

At step 6, G2LF/V2LF initializes the light field quilt RGB buffer (Q) and the transmittance buffer (T). These buffers store intermediate results and accumulate the final light field representation as the G2LF/V2LF algorithm progresses.

At steps 7-11, G2LF/V2LF enters a Swizzle blending loop, which iterates through the N_{chunk} volume chunks, progressively accumulating contributions to the light field quilt from different depths within the scene and adding them to the light field quilt buffers (Q, T) to composite the light field. Within the Swizzle blending loop, the Swizzle function is applied to compute the contribution of the current volume chunk to the light field quilt. The Swizzle function utilizes cached transmittance and color values of transmittance planes Tₖ and color planes Cₖ, along with accumulated transmittance from a transmittance buffer (T), to update the light field quilt buffer (Q). The loop continues until all volume chunks have been processed, building up the final light field representation in a single pass.

Within the Swizzle blending loop, normalized pixel coordinates U are determined using the Quilt2PlaneCoordinate function, which determines individual coordinates u′ according to:

$${u}^{′} = \frac{{( {D}_{focal} - {d}_{k} ) \cdot tan ( {ρ}_{J} )}^{\overbrace{Coordinate of the principal point .}} + {{d}_{k} \cdot tan ( 0.5 θ ) \cdot u}^{\overbrace{Offset from the principal point .}}}{( {d}_{k} - {D}_{forward} ) \cdot tan ( 0.5 {θ}^{′} )} .$$

Contributions of the current chunk are determined by interpolation using the cached transmittance planes Tₖ and color planes Cₖ, and the light field quilt buffers (Q, T) are updated according to:

$$C = {\sum }_{k = 1}^{{N}_{chunk}} ( {\prod }_{j = 1}^{j < k} {T}_{j} ) \cdot {C}_{k} .$$

By organizing the primitives into chunks, rasterizing them, and employing a plane sweep technique with cached values, the G2LF/V2LF algorithm efficiently generates high-quality light field quilts while minimizing computational overhead, enabling real-time or near-real-time rendering of complex 3D scenes (as represented by 3DGS or SVG representations) for light field displays.

In one or more embodiments, the G2LF/V2LF algorithm applies quantile binning to provide N_{chunk} chunks that each have a similar number of primitives (e.g., the number of primitives within each kth chunk is within a threshold range of the mean or median number of primitives of the N_{chunk} chunks). In at least one embodiment, quantile binning is applied by filtering Gaussians inside the view frustum of the reference camera and setting the chunking distances at N_{chunk}+1 linearly spaced percentiles using distances of Gaussian centers to the reference camera. The plane distance dₖ of kth plane is set to the median Gaussian distance of that chunk. In at least one embodiment, a CUDA rasterizer is utilized to perform 3D tiling (instead of the original 2D tiling) with an additional dimension for the chunks. Each respective Gaussian is assigned to a tile by its patch index and chunk index. The Gaussians in each 3D tile are sorted and rendered in parallel, thereby producing the forward-sweeping planes planes Tₖ and Cₖ.

In at least one embodiment, quantile binning is applied by filtering voxels in an analogous manner. In at least one embodiment, a CUDA-based sparse voxel rasterizer (SVR) is utilized which, instead of pre-filtering primitives, employs supersampling with anti-aliased downsampling to tackle aliasing issues. However, resizing the sweeping planes can be slow and double the GPU memory usage, especially with large N_{chunk} or high Pₛ. Therefore, in at least one embodiment, supersampling is disabled and a low-pass Gaussian filter is applied on the sweeping planes instead. In at least one embodiment, the low-pass Guassian filter is implemented in CUDA and performs filtering inplace without allocating extra memory.

In at least one embodiment, a hard-coded antialiasing filter is used such that a variance of a projected 2D Gaussian on screen space is dilated by 0.3 pixel, which causes a mismatch between conventional rendering and the sweeping-planes-based rendering from a reference camera with different plane resolution scaling factors Pₛ. In at least one embodiment, to align the sweeping-planes-based rendering with the conventional rendering, an adaptive filtering strength is provided by:

$${s}^{′} = s \cdot {( \frac{( {d}_{focal} \cdot tan ( 0.5 {θ}_{x} )}{( {d}_{focal} - {D}_{forward} ) \cdot tan ( 0.5 {θ}_{x}^{′} )} \cdot {P}_{s} )}^{2} ,$$

where, e.g., s=0.3 is the hard-coded dilation factor. The adaptive filtering strength is larger (in the screen space of the reference camera) when the pixel size of the reference camera on the focal plane is smaller than the conventional one.

FIG. 3B illustrates processing steps of the G2LF algorithm for rendering light field images from a 3D Gaussian Splatting (3DGS) representation. FIG. 3B illustrates input data consisting of 3D Gaussian primitives representing a 3D scene. These 3D Gaussian primitives then undergo sorting and chunking, whereby they are first culled by a given reference camera, then sorted along the z-axis based on their z-distance such that each chunk contains a similar number of Gaussian primitives. This approach helps balance the computational load across different depths of the scene. Thereafter G2LF rasterizes the Gaussians within the range of each respective chunk onto a 2D grid at the midplane of the respective chunk. Notably, the Gaussians are assigned to chunks based on their z-distance even though their lobes may expand to nearby chunk regions. This approach allows for efficient processing while still capturing the full extent of each Gaussian's contribution. The rasterization provides cached transmittance and color values for a plurality of transmittance planes Tₖ and a plurality of color planes Cₖ (for k=1, 2, . . . , N_{z}). FIG. 3B further illustrates a plane sweep that utilizes the Swizzle operation to compute accumulated transmittance and color values for each pixel of the light field quilt by approximating, e.g., interpolating, from cached transmittance and color values of the rasterized planes.

FIG. 3C illustrates processing steps of the V2LF algorithm for rendering light field images from a Sparse Voxel Grid (SVG) representation. FIG. 3C illustrates input data in the form of an SVG representing a 3D scene. The sparse voxels undergo sorting and chunking, whereby the voxels are grouped based on their centers into chunks along the z-axis. Similar to the G2LF algorithm, each chunk is designed to contain approximately the same number of voxels, balancing the computational load across different depths of the scene. Thereafter, V2LF rasterizes the voxel features from each respective volume chunk onto a 2D grid at the middle plane of the respective volume chunk. In at least one embodiment, the V2LF algorithm uses ray marching inside each voxel for RGB and alpha computation, rather than a 3D-to-2D splatting strategy used for Gaussians. This allows V2LF to leverage the structured nature of the voxel grid while maintaining the efficient plane-sweeping approach. The rasterization provides cached transmittance and color values for a plurality of transmittance planes Tₖ and a plurality of color planes Cₖ (for k=1, 2, . . . , N_{z}). FIG. 3C further illustrates a plane sweep that utilizes the Swizzle operation to compute accumulated transmittance and color values for each pixel of the light field quilt by approximating, e.g., interpolating, from cached transmittance and color values of the rasterized planes. The V2LF algorithm effectively combines the memory efficiency of sparse voxel grids (which unlike a NeRF, only stores data for occupied voxels) with the computational benefits of plane sweeping. By organizing the sparse data into coherent chunks and employing efficient rasterization and interpolation techniques, the algorithm can generate high-quality light field quilts while minimizing both memory usage and computational redundancy.

In one or more embodiments, an algorithm referred to as NeRF-to-Light Field (N2LF) is provided for rendering a light field quilt from a NeRF. In at least one embodiment, N2LF applies a quantile binning strategy in which a coarse network in NeRF is first utilized to render a roughly estimated depth map from the reference camera view and the depth points are subsequently quantiled to determine chunking positions. In at least one embodiment, to render sweeping planes from the reference camera, the occlusion term is ablated when performing hierarchical importance sampling along a ray so that occluded regions can still be sampled. In at least one embodiment, point colors and alphas from the final round of sampling are accumulated into different chunks based on their sampling positions.

Systems and methods provided herein simultaneously render multiple view images (i.e., which collectively form a light field quilt) from a 3D representation (e.g., a NeRF, a 3DGS representation, or an SVG) via a single-pass plane sweeping technique and caching of non-directional components, thereby significantly reducing computational overhead while maintaining high rendering accuracy. Each of the multiple view images is rendered as a perspective view captured by a perspective camera, and any 3D representation can be used as the input.

Systems and methods provided herein use cached color and transmittance values—which are determined for a reference viewpoint (e.g., a central view of the light field quilt)—to approximate (e.g., interpolate) color and transmittance values for ray-plane intersection points along rays that correspond to each pixel in the light field quilt, thereby eliminating repeated sampling of slightly shifted views.

A G2LF algorithm according to an embodiment and a V2LF algorithm according to an embodiment both achieved real-time performance (>30 FPS) for 90+ views of 512p images on consumer hardware (NVIDIA RTX 3090 Ti) while preserving image quality and correct perspective. By rendering a high-resolution light-field in real-time, these algorithms enable users to view a 3D scene while dynamically changing viewpoints—which can be seamlessly rendered in real-time—thereby providing an immersive and responsive 3D visualization experience.

More illustrative information will now be set forth regarding various optional architectures and features with which the foregoing embodiments may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

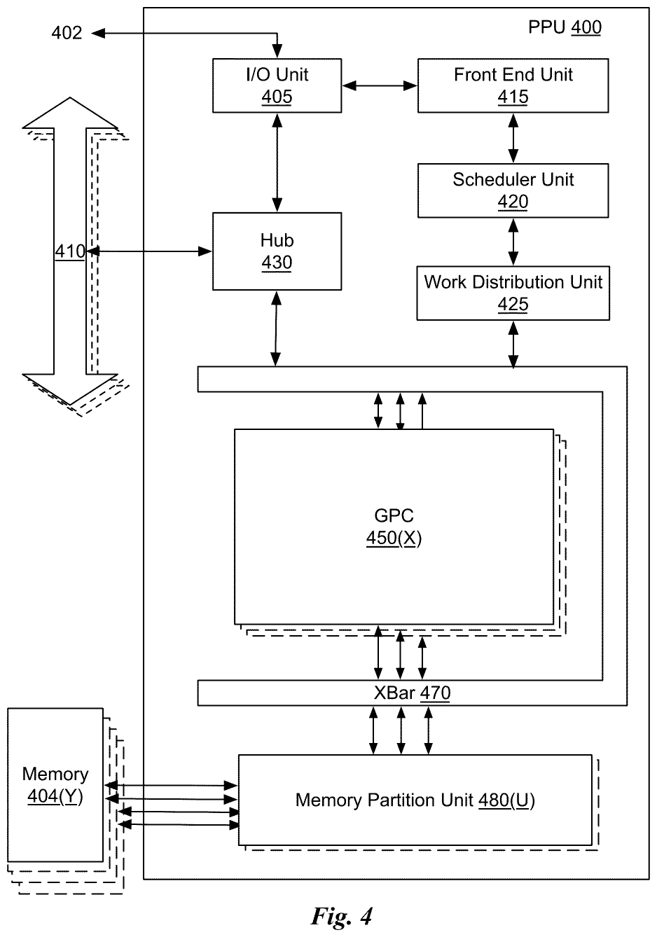

FIG. 4 illustrates a parallel processing unit (PPU) 400, in accordance with an embodiment. The PPU 400 may be used to implement one or more components of system 100. For example, the PPU 400 may be used to implement the rendering engine 104.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

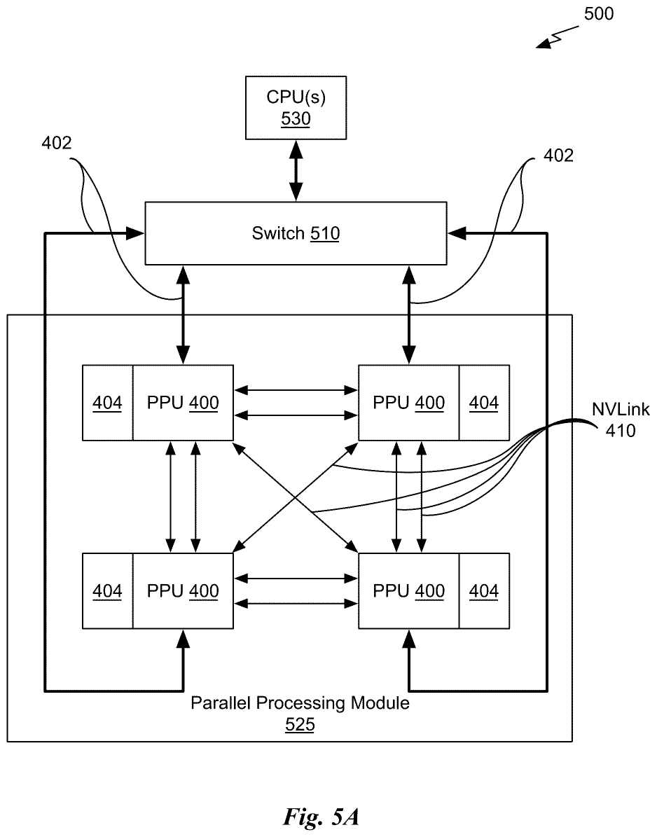

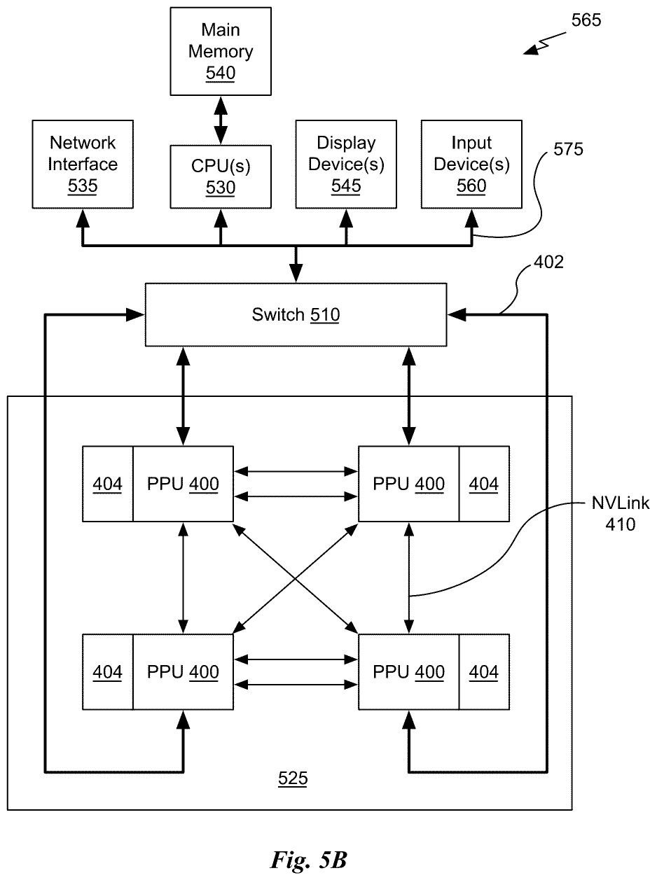

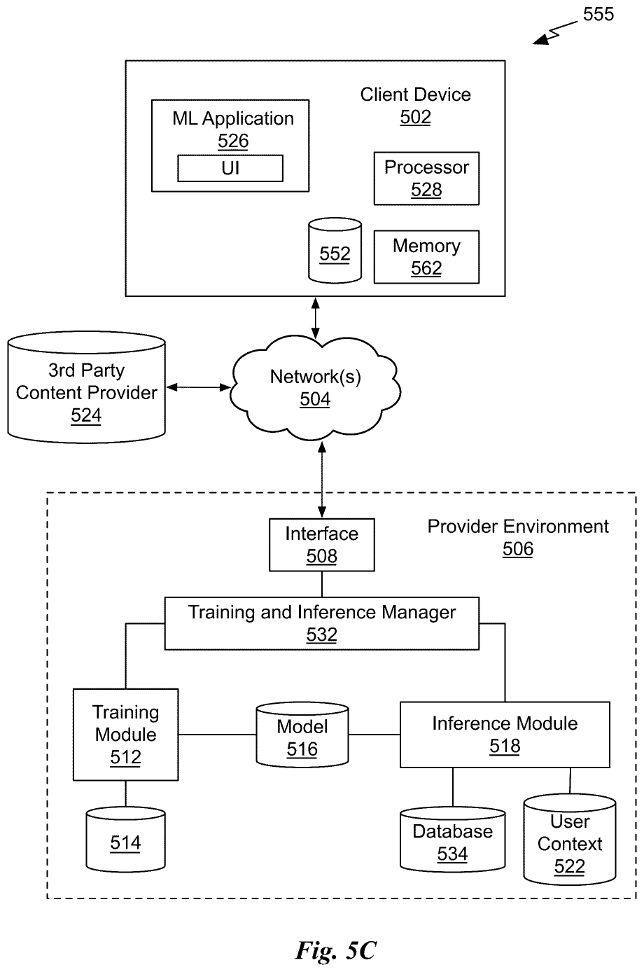

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 565 may be configured, e.g., to implement the method 200 shown in FIG. 2A. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured, e.g., to implement the method 200 shown in FIG. 2A.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

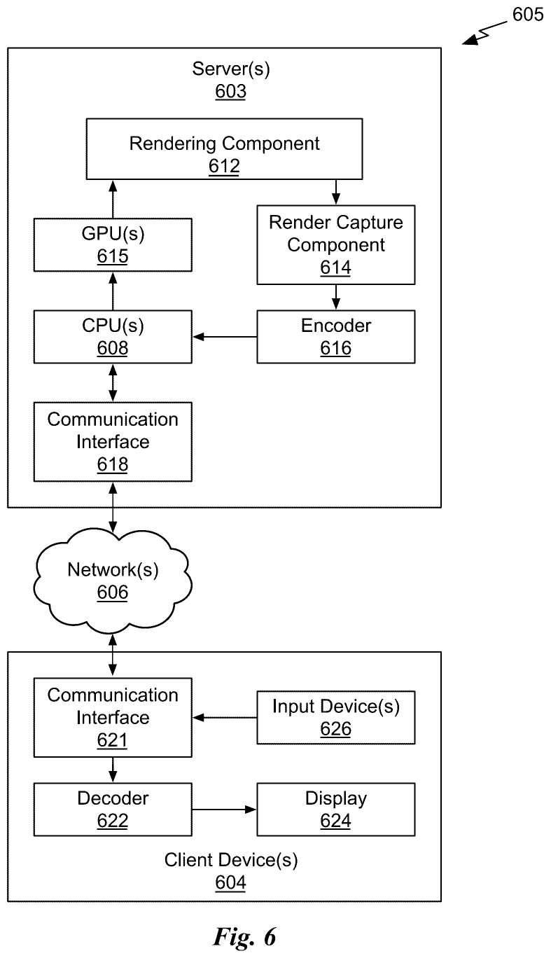

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for rendering multiple view images from a three-dimensional (3D) representation of a scene, the method comprising:
obtaining the 3D representation;
determining a plurality of volume chunks;
computing, for respective sampling points in each of the plurality of volume chunks, transmittance and color values corresponding to rays extending from the respective sampling points to a reference view, thereby providing a plurality of color planes comprising computed color values and a plurality of transmittance planes comprising computed transmittance values;
caching the computed color values and the computed transmittance values; and
performing a plane sweep operation to generate the multiple view images.

2. The method of claim 1, wherein the multiple view images form a light field quilt corresponding to a plurality of views, and wherein the plane sweep operation approximates color and transmittance values corresponding to pixels of the multiple view images using the cached color values and the cached transmittance values.

3. The method of claim 1, wherein the 3D representation is a neural radiance field (NeRF), and wherein determining the plurality of volume chunks comprises:
generating, by using the NeRF to compute density values for different points in the scene, a depth map of the scene; and
partitioning the scene into the plurality of volume chunks based on the depth map.

4. The method of claim 1, wherein the 3D representation is a 3D Gaussian splatting (3DGS) representation or a sparse voxel grid (SVG) representation, and wherein determining the plurality of volume chunks comprises:
culling primitives based on the reference view;
sorting remaining primitives based on their distance to the reference view; and
partitioning the scene into the plurality of volume chunks such that each volume chunk contains a number of primitives that falls within a threshold range of a mean number of primitives or a median number of primitives.

5. The method of claim 1, wherein each volume chunk of the plurality of volume chunks comprises a uniform number of sampling points.

6. The method of claim 1, wherein a number of sampling points in a respective volume chunk of the plurality of volume chunks is determined from a distance of the respective volume chunk from a focal depth of the reference view.

7. The method of claim 1, wherein computing the transmittance values and the color values comprises rasterizing primitives assigned to each respective volume chunk of the plurality of volume chunks onto a 2D grid located at a midplane of the respective volume chunk.

8. The method of claim 1, wherein performing the plane sweep operation comprises, for one or more respective volume chunks of the plurality of volume chunks:
computing a color contribution and a transmittance contribution of the respective volume chunk for one or more respective pixels in the multiple view images by, for each respective pixel of the one or more respective pixels:
determining a point of intersection of a ray corresponding to the respective pixel and a sampling plane corresponding to the volume chunk, and
approximating, based on the determined point of intersection and one or more cached transmittance values and one or more cached color values, a respective transmittance contribution and a respective color contribution corresponding to the respective pixel; and
compositing the respective transmittance contributions with corresponding previously computed transmittance values and compositing the respective color contributions with corresponding previously computed color values.

9. The method of claim 2, further comprising specifying parameters of the light field quilt, wherein the parameters of the light field quilt comprise: a number of views in an x-direction, a number of views in a y-direction, an angular spread of views in the x-direction, an angular spread of views in the y-direction, and a resolution of each view.

10. The method of claim 1, wherein the multiple view images are a plurality of perspective view images, each perspective view image corresponding to a unique view.

11. The method of claim 1, further comprising providing the multiple view images to a 3D display device for visualization, wherein the 3D display device is one of a light field display, a multi-view display, or a holographic display.

12. A system for rendering multiple view images from a three-dimensional (3D) representation of a scene, the system comprising:
one or more processors configured to:
obtain the 3D representation;
determine a plurality of volume chunks;
compute, for respective sampling points in each of the plurality of volume chunks, transmittance and color values corresponding to rays extending from the respective sampling points to a reference view, thereby providing a plurality of color planes comprising computed color values and a plurality of transmittance planes comprising computed transmittance values;
cache the computed color values and the computed transmittance values; and
perform a plane sweep operation to generate the multiple view images; and
one or more memories configured to store computed color values and the computed transmittance values.

13. The system of claim 12, wherein the multiple view images form a light field quilt corresponding to a plurality of views, and wherein the plane sweep operation approximates color and transmittance values corresponding to pixels of the multipleview images using the cached color values and the cached transmittance values.

14. The system of claim 12, wherein the 3D representation is a neural radiance field (NeRF), and wherein determining the plurality of volume chunks comprises:
generating, by using the NeRF to compute density values for different points in the scene, a depth map of the scene; and
partitioning the scene into the plurality of volume chunks based on the depth map.

15. The system of claim 12, wherein the 3D representation is a 3D Gaussian splatting (3DGS) representation or a sparse voxel grid (SVG) representation, and wherein determining the plurality of volume chunks comprises:
culling primitives based on the reference view;
sorting remaining primitives based on their distance to the reference view; and
partitioning the scene into the plurality of volume chunks such that each volume chunk contains a number of primitives that falls within a threshold range of a mean number of primitives or a median number of primitives.

16. The system of claim 12, wherein each volume chunk of the plurality of volume chunks comprises a uniform number of sampling points.

17. The system of claim 12, wherein a number of sampling points in a respective volume chunk of the plurality of volume chunks is determined from a distance of the respective volume chunk from a focal depth of the reference view.

18. The system of claim 12, wherein performing the plane sweep operation comprises, for one or more respective volume chunks of the plurality of volume chunks:
computing a color contribution and a transmittance contribution of the respective volume chunk for one or more respective pixels in the multiple view images by, for each respective pixel of the one or more respective pixels:
determining a point of intersection of a ray corresponding to the respective pixel and a sampling plane corresponding to the volume chunk, and
approximating, based on the determined point of intersection and one or more cached transmittance values and one or more cached color values, a respective transmittance contribution and a respective color contribution corresponding to the respective pixel; and
compositing the respective transmittance contributions with corresponding previously computed transmittance values and compositing the respective color contributions with corresponding previously computed color values.

19. A non-transitory processor-readable medium having stored thereon processor executable instructions that, when executed by one or more processors, cause the one or more processor to perform a method for rendering multiple view images from a three-dimensional (3D) representation of a scene comprising:
obtaining the 3D representation;
determining a plurality of volume chunks;
computing, for respective sampling points in each of the plurality of volume chunks, transmittance and color values corresponding to rays extending from the respective sampling points to a reference view, thereby providing a plurality of color planes comprising computed color values and a plurality of transmittance planes comprising computed transmittance values;
caching the computed color values and the computed transmittance values; and
performing a plane sweep operation to generate the multiple view images.

20. The non-transitory processor-readable medium of claim 19, wherein performing the plane sweep operation comprises, for one or more respective volume chunks of the plurality of volume chunks:
computing a color contribution and a transmittance contribution of the respective volume chunk for one or more respective pixels in the multiple view images by, for each respective pixel of the one or more respective pixels:
determining a point of intersection of a ray corresponding to the respective pixel and a sampling plane corresponding to the volume chunk, and
approximating, based on the determined point of intersection and one or more cached transmittance values and one or more cached color values, a respective transmittance contribution and a respective color contribution corresponding to the respective pixel; and
compositing the respective transmittance contributions with corresponding previously computed transmittance values and compositing the respective color contributions with corresponding previously computed color values.
